(19) United States
(12) Patent Application Publication
(10) Pub. No.: US 2005/0125505 A1
(43) Pub. Date: Jun. 9, 2005

(54) Picture providing service system and the method thereof

(76) Inventors: Jong-Kyung Kim, Seongnam-si (KR); Sun-Young Kwon, Seoul (KR)

Correspondence Address: Robert E. Bushnell, Suite 300, 1522 K Street, N.W., Washington, DC, 20005-1202, US

(21) Appl. No.: 10/716,414

(22) Filed: Nov. 20, 2003

(51) Int. Cl. H04N 7/14; H04N 5/232; G06F 15/16

(52) U.S. Cl. 709/219; 348/211.12; 348/14.01

(57) ABSTRACT

A picture providing service system, and the method thereof, with which users, being connected to a communication network, can use the contents with seeing other users' appearances, are disclosed. The picture providing service system comprises a user administration means for storing the information on the users, who want to use picture-related contents with being connected to a content providing system, into a database and administrating them; a video data processing means for storing each user's video data inputted through his(or her) PC having a digital camera into the database and editing the video data according to the user's control; an image data processing means for providing various images to the users, storing the images selected by the users into the database, and editing the selected images according to the users' demands respectively, and a data synthesizing means for synthesizing the video data and the image data.

### BACKGROUND OF THE INVENTION

1. Field of the Invention

The present invention relates to a picture providing system using a digital camera. In more detail, it relates to a picture providing service system with which users, being connected to a communication network, can use the contents with seeing other users' appearances and the method thereof.

2. Description of the Related Art

As personal computers (PCs) and Internet are being popularized, businesses for providing various contents to users using Internet are being rapidly developed. Among the various contents provided through Internet, chatting service has been being spotlighted as a representative content service from the past generation, when PC communication was being performed through telephone line, to the present.

Chatting service is a service with which numbers of users, being connected to a communication network, can talk to each other through messages. Nowadays, owing to the high transmission speed of network and the massive scale of PC, a video chatting service, with which a user can send/receive messages with seeing his (or her) chatting companion's appearance by using an image processing device like a digital camera equipped in his (or her) PC, is being universalized. Different from the prior chatting service only transferring the messages, a video chatting service provides image windows displaying chatters' features so that it can increase the chatting interest. However, a video chatting is generally being accomplished by using a digital camera placed in front of a user, and thus it often causes a problem that the user's background space, which the user does not want to be seen by others, is being disclosed. Besides, in case that numbers of users are connected to a chatting room to use a video chatting service, it is difficult to find any characteristic features in the displayed pictures of the users, and thus it is very hard to identify each of the users in a short period of time.

To compensate these disadvantages, a method of changing the color-feeling of video data by controlling the hardware options of an image-processing device like setting the image-processing device to be operated in a black-and-white mode: However, this kind of method only changes the overall color composition and still cannot express each user's individual characteristics. Moreover, it has a problem that the displayed picture quality is often distorted according to the configuration of the image-processing device, and thus most users generally use the video data inputted into the image-processing device without any modification.

Recently, not only in a video chatting service but also in an electronic commerce, Internet meeting, Internet dating service, etc., various types of services, with which the participants can use the contents with seeing other participants' appearance by using an image-processing device, are being developed and provided. In these types of services, however, the inputted picture information is directly displayed on the other users' computers, and thus the individual characteristics can hardly be expressed and the numbers of user-pictures are being displayed similar to one another.

### SUMMARY OF THE INVENTION

The present invention is proposed to solve the problems of the prior art mentioned above. It is therefore the object of the present invention to provide a picture providing service system that can express a user's picture characteristically by synthesizing image information into the user information inputted through an image-processing device and the method thereof.

It is another object of the present invention to provide a picture providing service system, and the method thereof, that can prevent the degradation of the picture-quality and the color-feeling of a picture, occurred in modification process on the picture information, by synthesizing the user's picture information displayed on a computer without a hardware change of the image-processing device.

To achieve the object mentioned above, the present invention provides a picture providing service system that provides picture data to a user, who is using picture-related contents, with being connected to a content providing system providing a service on Internet. The system comprises a user administration means for storing the personal information, identification information and the picture-related information of a user, who wants to use picture-related contents, among the users using the contents with being connected to the content providing system into a database and administrating them; a video data processing means for storing the user's video data inputted through his (or her) PC having a digital camera into the database and editing the video data according to the user's control; an image data processing means for providing various images to the user, and when the user selects a preferred image, storing the selected image into the database and editing the selected image according to the user's demand; and a data synthesizing means for synthesizing the video data and the image data.

Here, the picture-related contents include the contents used for a video chatting, a video electronic commerce, a video meeting, a video dating service, and so on. In addition, the video data processing means has the functions of partially deleting and/or surface-processing the video data according to the user's control, and the image data processing means has the functions of performing a size-control, an image-combination, and/or a color-change on the selected image data.

In addition, the present invention also provides a picture providing service method for providing picture data to a user using picture-related contents with being connected to a content providing system providing a service on Internet, characterized by comprising the steps of: (a) when a user, being connected to the content providing system, wants to use one of the picture-related contents, checking that video data is being inputted from the user's PC; (b) if the user's video data is being inputted, checking that the user wants to select an image data; (c) if the user wants to use an image data and selects a preferred image, checking that the user wants that the video data and the image data are to be synthesized together; (d) if the user wants to use the selected image data only without synthesizing the data, transmitting the selected image data to the content providing system; and (e) if the user wants to synthesize the video data and the image data, synthesizing the user's video data and the selected image data and transmitting the synthesized data to the content providing system.

### BRIEF DESCRIPTION OF THE DRAWINGS

FIG. 1 is a view illustrating an example of a communication network where a picture providing service system in accordance with the present invention is being applied.

FIG. 2 is a structural diagram illustrating the detailed structure of the picture providing service system described in FIG. 1.

FIG. 3 is a flowchart illustrating the procedures of a picture providing service method in accordance with the present invention.

FIG. 4 is a block diagram illustrating an embodiment of the picture providing service method in a chatting room in accordance with the present invention.

### DETAILED DESCRIPTION OF THE EMBODIMENTS

Hereinafter, referring to appended drawings, the preferred embodiments of the present invention are described in detail.

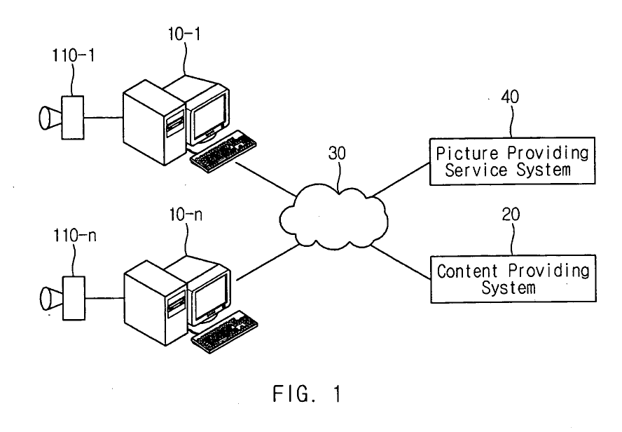

In the description described hereinafter, “video data” represents the data corresponding a user's actual appearance inputted through an image-processing device, “image data” represents the graphic data able to be synthesized with the video data such as a background image and so forth, and “synthesized data” represents the data obtained by synthesizing the video data and the image data. FIG. 1 is a view illustrating an example of a communication network where a picture providing service system in accordance with the present invention is being applied.

As described in the figure, an image-processing device like a digital camera 110-1·110-n can be installed at a PC 10-1˜10-n. With using this kind of PC system, a user can be connected to a content providing system 20 through Internet 30 to use various types of services provided by the content provider. The services provided to the users by the content providing system 20 include the entire services able to be provided through Internet as well as the services, with which the participating users can use the contents with seeing the other users appearances, such as a video chatting, a video electronic commerce, a video meeting, a video dating service, and so on.

A picture providing service system 40 is a system, connected to a content providing system 20, that creates and provides a preferred picture data to a user who is being connected to the content providing system 20 and wants to use picture-related contents. A picture providing service system 40 can be operated by the operator of a content providing system 20, or by another operator independent of the content providing system.

Using a PC 10-1˜10-n having a digital camera 110-1˜110-n, a user connects to a content providing system 20 through Internet 30. Then, the user, being connected to the content providing system 20, selects a desired service among the various types of services such as chatting, electronic commerce, meeting, dating service, etc.. At this time, the user also selects how to manipulate his (or her) appearance, inputted through the image-processing device, to be disclosed to the others. If the user wants to display the video data inputted into the digital camera 110-1˜110-n unmodified, the picture providing service system 40 gives no additional manipulation to the inputted video data and transmits the video data to the content providing system 20. On the other hand, if the user wants to display the video data inputted into the digital camera 110-1˜110-n with being synthesized with an additional image, the picture providing service system 40 provides various image information to the user, synthesizes the video data with the image data selected by the user, and transmits the synthesized data to the content providing system 20. In this case, the additional image can be provided by the picture providing service system 40, however, it is also possible that the additional image is selected among the images stored in the user's PC 10-1˜10-n or an extra storing means. 100201 After being connected to the picture providing service system 40, a user can download a data-synthesis-related application program to his (or hers) own PC 10-1˜10-n. And then, the process for synthesizing the video data and the image data can be carried out by the user's PC 10-1˜10-n using the application program. With this procedure, the load applied to the picture providing service system 40 can be reduced, and thus the data processing speed can be increased.

If a synthesized data, obtained by synthesizing a video data and an image data as described above, is being displayed, the appearance of the user can be remarkably displayed compared with those of the other users using the unmodified video data.

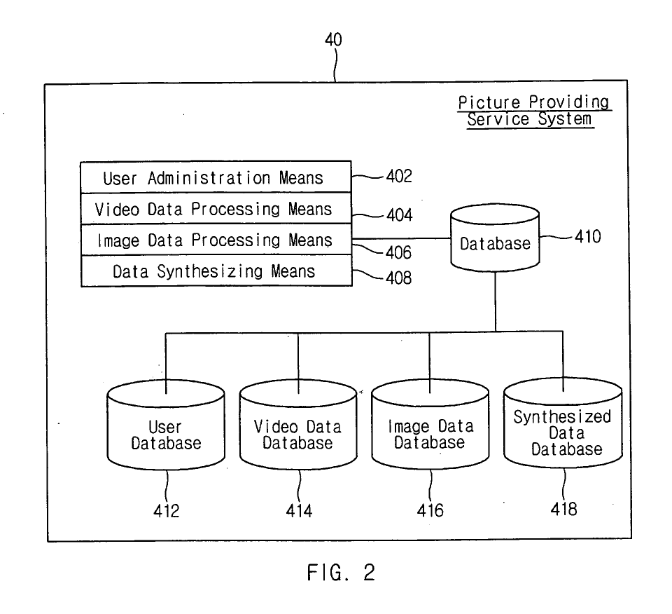

FIG. 2 is a structural diagram illustrating the detailed structure of the picture providing service system described in FIG. 1.

As described in FIG. 2, a picture providing service system 40 in accordance with the present invention comprises a user administration means 402, a video data processing means 404, an image data processing means 406, a data synthesizing means 408, and a database 410. Here, the database 410 includes a user database 412, a video data database 414, an image data database 416, and a synthesized data database 418. These databases can be constituted in a single table or in four different tables respectively.

The user administration means 402 stores the personal information, the identification information and the picture-related information of a user, who wants to use picture-related contents, among the users using the contents with being connected to the content providing system 20 into the user database 412 and administrates them.

The video data processing means 404 stores the user's video data inputted into the picture providing service system 40 through the digital camera 110-1˜110-n into the video data database 414 and edits the video data according to the user's control. The image data processing means 406 provides various images stored in the image data database 416 of the picture providing service system 40 to the user, and when the user selects a preferred image, stores the selected image data into the image data database 416 for each user, and edits the selected image according to the user's demand.

The image data stored in the image data database 416 includes the images, able to be overlapped on the video data such as a background image, a hairstyle, glasses, clothes, etc., and various types of avatars with which a user can express himself (or herself) by the image data only without using the video data.

Here, the edition of the video data can be carried out by selecting some portion of video data which the user wants to be displayed and deleting the rest of the video data, surface-processing on the video data, and so on. The edition of the image data includes fitting the size of the image, provided by the picture providing service system 40, to the user's face, selecting various partial image data provided by the system and combining them, selecting preferred colors, and the like.

The data synthesizing means 408 synthesizes the video data and the image data. That is to say, when a user, who is using the contents, wants to display his (or her) appearance on the other users' computer-screens by using the synthesized data of the video data and the image data, the data synthesizing means 408 combines the video data, inputted through the digital camera 110-1˜110-n installed at the user's PC 10-1˜10-n and edited/stored by the video data processing means 404, and the image data, selected by the user and edited/stored by the image data processing means 406, and then stores the combined data into the synthesized data database 418. Here, the combination of the video data and the image data can be achieved simply by overlapping the pictorial information.

In another embodiment of the present invention, the process for synthesizing the video data and the image data can be carried out by a user's PC 10-1˜10-n by letting the user to download a data-synthesis-related application program from the picture providing service system 40 to his (or hers) own PC 10-1˜10-n after being connected to the system 40. With this procedure, the load applied to the picture providing service system 40 can be reduced, and thus the data processing speed can be increased.

The picture providing service system 40 further comprises a network interface (not described in the figure) for transmitting the process-completed video data, image data, and synthesized data to the content providing system 20. In addition, the user's video data is transmitted to the picture providing service system 40 through the content providing system 20.

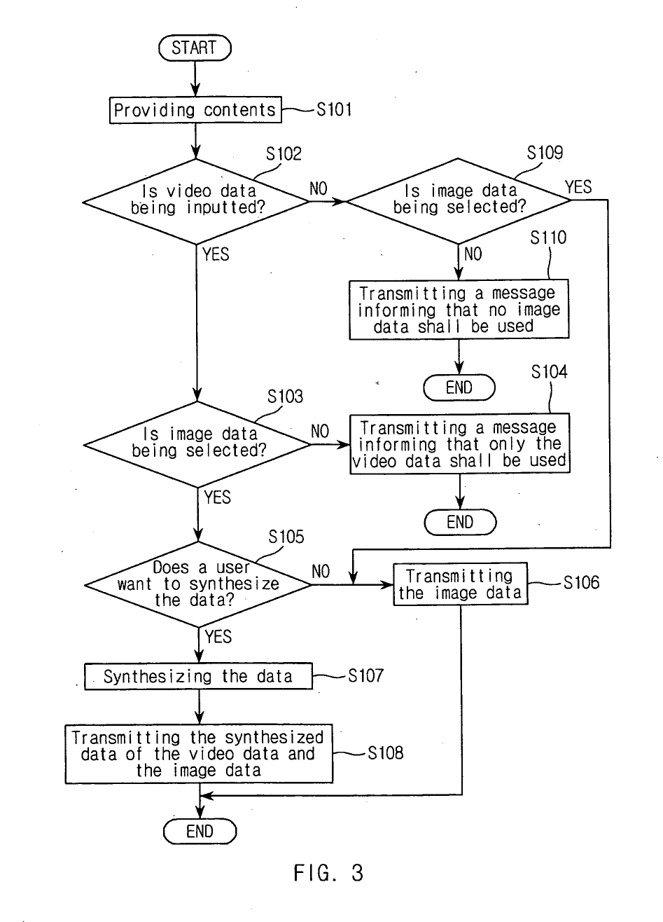

FIG. 3 is a flowchart illustrating the procedures of a picture providing service method in accordance with the present invention.

The content providing system 20 is connected to the picture providing service system 40 to provide picture-related contents to users. And when a user, being connected to the content providing system 20, wants to use picture-related contents, the picture providing service system 40 is promptly activated to provide the corresponding picture information to the user's demand. The picture providing service can be provided simultaneously at the beginning of the contents being provided, however, it is also available for a user to change his (or her) appearance while using the contents.

The detailed procedures for providing pictures to a user are as follows:

When a user, being connected to the content providing system 20, wants to use one of the picture-related contents that the participating users can use with seeing other users' appearances such as a video chatting, a video electronic commerce, a video meeting, a video dating service, etc., the content providing system 20 provides the corresponding content S101. At this time, since the content provided to the user is a picture-related content, the picture providing service system 40 is promptly being activated and checks that the user's video data is being inputted S102. If the user's video data is being inputted, it checks that the user wants to use the video data only or to select additional image data to be used S103.

If the user does not select an additional image data, the picture providing service system 40 informs that to the content providing system 20, so that the user's video data is being displayed, is without any modification, on the computer-monitors of other users using the corresponding content together S104. On the other hand, if the user wants to use additional image data and selects a preferred image, the picture providing service system 40 checks that the user wants to synthesize the image data and the video data or to use the image data only S105.

If the user wants to use the selected image data only without synthesizing the data in the step of S105, the picture providing service system 40 transmits the selected image data to the content providing system 20, S106, so that the image data is being displayed on the computer monitors of other users using the corresponding content together. On the other hand, if the user wants to synthesize the data, the data synthesizing means 408 of the picture providing system 40 synthesizes the user's video data and the selected image data S107, stores the synthesized data into the synthesized data database 418, and transmits the synthesized data to the content providing system 20, S108. Here, the image data, which is being synthesized with the video data, can be provided by the picture providing service system 40. Or, it can also be selected among the images stored in the user's PC 10-1˜10-n or an extra storing means able to be read by the user's PC 10-1˜10-n.

In the step S107 of synthesizing the video data and the image data, the video data is first edited by the user selecting a desired portion of the data to be displayed. And then, the synthesized data is produced by overlapping the selected image data onto the edited video data. The process for synthesizing the video data and the image data can be carried out either by the picture providing service system 40 or by the user's PC 10-1˜10-n by letting the user to download a data-synthesis-related application program from the picture providing service system 40 to his (or hers) own PC 10-1˜10-n.

Besides, if it is noticed that the user's video data is not being inputted in the step S102 of checking that the user's video data is being inputted, the picture providing service system 40 checks that the user wants to selects image data S109. If the user selects image data, it transmits the selected image data to the content providing system 20, S106. Or else, it informs to the content providing system 20 that the user is not using a picture data.

In another embodiment of the present invention, the video data processing means 404 can edit the corresponding video data according to the demand of a user who wants to use the video data only, and the image data processing means 406 can edit the corresponding image data according to the demand of a user who wants to use the image data only. The edition of video data includes a deletion of specific portion, surface processing, etc., and the edition of image data includes size-control, combination-of-images, color selection, and so on.

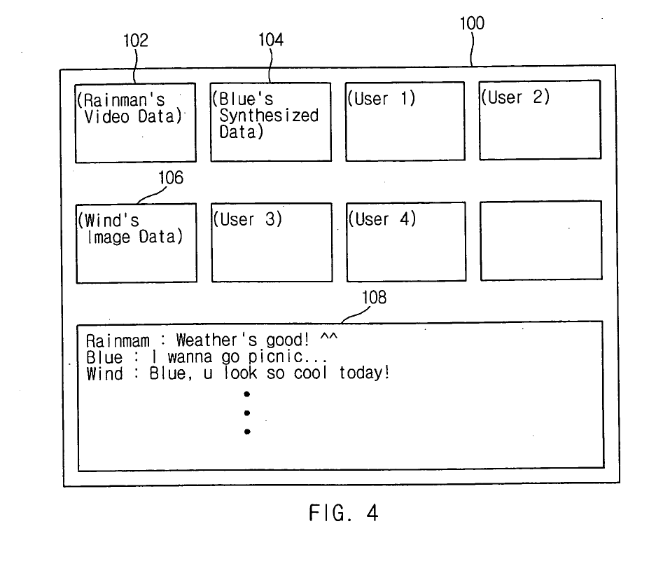

FIG. 4 is a block diagram illustrating an embodiment of the picture providing service method in a chatting room in accordance with the present invention.

In case of a video chatting service, the user displaying windows 102, 104, 106, where the picture information of the participating users (Rainman, Blue, Wind, User1˜User4) in a chatting room are being displayed, are appeared on the upper portion of a monitor 100, and the conversation window 108 is appeared on the bottom. Each individual user participating in the chatting room can use video data or image data only, or use synthesized data of video data and image data. Or in occasion, he (or she) does not use any picture data.

In case that most participating users in a chatting room are displaying themselves by using the video data only, each of the users' appearance displayed on the user displaying windows can hardly express any characteristics distinguishable from one another, and thus the chatting is going on with less interest. However, if a user uses a synthesize data combining the video data and image data according to his (or her) preference, he (or she) can express himself (or herself) by a distinguishable picture from those of the other users. In addition, each user can change his (or her) appearance according to the subject and/or the atmosphere of the chatting room, and thus all the participating users can use the service under the more interesting circumstances.

As described thereinbefore, the picture providing service system of the present invention can be used by a user while he (or she) is using on-line contents on Internet, however, it can also be used for a user to create his (or her) own character by providing the system able to be stored in CD, ROM-BIOS, or the like. In this case, the entire processes for providing/processing the video/image data and synthesizing the video/image data are being carried out by the user's PC 10-1˜10-n.

As mentioned thereinbefore, the present invention provides a synthesized picture data, produced by combining an image data satisfying a user's preference into the video data inputted through an image-processing device, to the user using picture-related contents, so that the user can display himself (or herself) with expressing his (or her) individual characteristics.

In addition, a user can change his (or her) appearance according to the subject and/or the atmosphere of a service by using the present invention, and thus all the participating users can use the service under the more interesting circumstances.

Since those having ordinary knowledge and skill in the art of the present invention will recognize additional modifications and applications within the scope thereof, the present invention is not limited to the embodiments and drawings described above. The scope of the present invention is therefore to be represented by the claims that will be described hereinafter, and it is needless to say that the claims of the present invention are to be interpreted to include all the non-inventive modifications and applications able to be derived from the subjects of themselves and their equivalents.

1. A picture providing service system, that provides picture data to a user using picture-related contents with being connected to a content providing system providing a service on Internet, comprising:
a user administration means for storing the personal information, the identification information and the picture-related information of a user, who wants to use picture-related contents, among the users using the contents with being connected to said content providing system into a database and administrating them;
a video data processing means for storing said user's video data inputted through his (or her) PC having a digital camera into said database and editing said video data according to said user's control;
an image data processing means for providing various images to said user, and when said user selects a preferred image, storing said selected image into said database and editing said selected image according to said user's demand; and
a data synthesizing means for synthesizing said video data and said image data.

2. A picture providing service system as claimed in claim 1, wherein said picture-related contents include the contents used for a video chatting, a video electronic commerce, a video meeting, and a video dating service.

3. A picture providing service system as claimed in claim 1, wherein said video data processing means partially deletes said video data and/or carries out a surface-processing on said video data according to said user's control.

4. A picture providing service system as claimed in claim 1, wherein said image data processing means carries out a size-control, an image-combination, and/or a color change on said selected image data.

5. A picture providing service system as claimed in claim 1, wherein said data synthesizing means overlaps said video data and said image data.

6. A picture providing service method for providing picture data to a user using picture-related contents with being connected to a content providing system providing a service on Internet, comprising the steps of:
(a) when said user, who is being connected to said content providing system, wants to use one of said picture-related contents, checking that video data is being inputted from said user's PC;
(b) if said user's video data is being inputted, checking that said user wants to select image data;
(c) if said user wants to use image data and selects a preferred image, checking that said user wants that said video data and said image data are to be synthesized together;
(d) if said user wants to use said selected image data only without synthesizing the data, transmitting said selected image data to said content providing system; and
(e) if said user wants to synthesize said video data and said image data, synthesizing said user's video data and said selected image data and transmitting the synthesized data to said content providing system.

7. A picture providing service method as claimed in claim 6, wherein said picture-related contents include the contents used for a video chatting, a video electronic commerce, a video meeting, and a video dating service.

8. A picture providing service method as claimed in claim 6, wherein said step of synthesizing said user's video data and said selected image data in said step (e) comprises:
a video data editing process for said user to select a desired portion of said video data to be displayed; and
a combining process for overlapping said selected image data onto said edited video data.

9. A picture providing service method as claimed in claim 6, characterized by further comprising, after said step (a), the steps of:
if said user's video data is not being inputted, checking that said user wants to select image data;
if said user selects image data, transmitting said selected image data to said content providing system; and
if said user does not select image data, informing to said content providing system that said user is not using a picture data.

10. A picture providing service method as claimed in claim 6, characterized by further comprising, after said step (b), the step of, if said user does not select image data, informing to said content providing system that said user is using said video data only.

11. A picture providing service method as claimed in claim 10, characterized by further comprising the step of, if said user wants to use said video data only, editing said video data according to said user's demand.

12. A picture providing service method as claimed in claim 11, wherein said edition of said video data includes a partial-deletion and a surface-processing

13. A picture providing service method as claimed in claim 6, characterized by further comprising the step of, if said user wants to use said image data only in step (d), editing said image data according to said user's demand.

14. A picture providing service method as claimed in claim 13, wherein said edition of said image data includes a size-control, an image-combination, and a color-selection.
